(19) United States
(12) Patent Application Publication
(10) Pub. No.: US 2018/0284353 A1
(43) Pub. Date: Oct. 4, 2018

(54) FIBER HOLDING TOOL FOR THE FUSION SPLICER

(71) Applicant: INNO INSTRUMENT (CHINA) .INC, WeiHai (CN)

(72) Inventor: Yangri ZHAO, WeiHai (CN)

(21) Appl. No.: 15/723,487

(22) Filed: Oct. 3, 2017

(30) Foreign Application Priority Data
Mar. 29, 2017 (CN) 201710195757.4

(51) Int. Cl. G02B 6/36; G02B 6/255

(52) U.S. Cl. CPC G02B 6/3616; G02B 6/3858; G02B 6/2551; G02B 6/2553

(57) ABSTRACT

The present invention discloses a fiber holding tool for the fusion splicer which comprises a body and a cover, among which, the said body and the cover are pivotally connected by a rotating shaft. The said body is provided with a fiber accommodating groove as well as a fiber limiting front portion and a fiber limiting rear portion, and the said fiber accommodating groove is provided with a rib. The said cover is provided with a fiber fixing portion used for fixing fibers, and the said fiber fixing portion is provided with an elastic body. The present invention can achieve holding and clamping of a 12-core ribbon fiber having a diameter of 200 μm, and facilitates the new fiber to use the original fusion splicer, to ensure the quality of welding while reducing costs.

### TECHNICAL FIELD

The present invention relates to the field of fiber holder, specifically to a fiber holding tool suitable for use in fiber cleavers and fusion splicers.

### BACKGROUND

The optical fiber, a shorthand for light guide fiber, is a fiber made of glass or plastic, which can be used as a light conducting tool. A ribbon fiber is formed in such a manner that a multi-core fiber (4, 6, 8, 12-core, etc.) is stuck together using a special material to form a pair (aka a ribbon), and a fiber cable is formed by multiple pairs (ribbons) in accordance with the relevant standard, and the most commonly used ones include 6-core and 12-core ribbon fibers. The previously mentioned ribbon fiber is mainly composed of ribbon fibers having a diameter of 250 μm (including coating). With the development of optical fiber technology, a ribbon fiber having a diameter of 200 μm (including coating) has recently appeared. The original fiber holding tool cannot be used for the new ribbon fiber, and the new ribbon fiber fails to be placed on the original fusion splicer for welding.

Patent CN200680001870.4 discloses a fiber holder which is mainly composed of a base, a cover and a limiting part, and the fiber holder can be used to hold the ribbon fiber.

However, this holder cannot solve the clamping problem of a 200 μm (including coating) ribbon fiber, and the use of this holder cannot allow a new ribbon fiber to be welded by the original fusion splicer, and in the field of engineering operations, the purchase of new fusion splicers often cost too much.

### SUMMARY

The present invention is to compensate for the above-mentioned drawbacks of the prior art, providing a fiber holding tool capable of clamping and splicing a fiber using the original fusion splicer.

The technical problem of the invention can be solved by the following technical proposals:

A fiber holding tool for the fusion splicer comprises a body 1 and a cover 2, among which, the said body 1 and the cover 2 are pivotally connected by a rotating shaft 3. The said body 1 is provided with a fiber accommodating groove 11, and the said fiber accommodating groove 11 penetrates the said body 1 in the lengthwise direction; the said fiber accommodating groove is provided with a rib 12, and the said rib 12 is parallel to the two longer sides of the said fiber accommodating groove 11 and divides the said fiber accommodating groove 11 into two halves in the widthwise direction.

Further, the said cover 2 is provided with a fiber fixing portion 21 for fixing the fiber, and shorter than the said body 1.

Further, the said rib 12 is longer than or equal to the said cover 2, but shorter than the said fiber accommodating groove 11.

Further, the said body 1 is provided with a fiber limiting front portion 13 and a fiber limiting rear portion 14, and the upper surface of the said fiber limiting front portion 13 and the said fiber limiting rear portion 14 is higher than the said fiber accommodating groove 11.

Further, the said fiber accommodating groove 11 is used for placing a 12-core ribbon fiber having a diameter of 200 μm, and both sides from the said rib 12 to the said fiber accommodating groove 11 are respectively used for placing a 6-core fiber having an inner diameter of 200 μm, and the width of the said fiber accommodating groove 11 is set between 2.80 mm and 2.84 mm.

Further, the said fiber fixing portion 21 on the said cover 2 is provided with an elastic body 22, and the said elastic body protrudes from the inner surface of the said cover 2.

Further, the said body 1 is also provided with an elastic body accommodating groove 16 which is located at both sides of the said fiber accommodating groove 11. The said elastic body accommodating groove 16 is longer than or equal to the said elastic body 22 in length, and fit with the said elastic body 22 in height and width, with its bottom higher than the said fiber accommodating groove 11 but lower than the said fiber limiting front portion 13 and fiber limiting rear portion 14.

Further, the said body 1 is provided with a magnet 15, and the said cover 2 is made of a magnetic material. One end of the said cover 2 may be connected to the said body 1 through the magnet 15 to close the said cover.

Further, the said body 1 is also provided with a plurality of connection fixing holes 17 for permanent connection with fiber cleavers and fusion splicers.

The beneficial effects of the present invention are:

1. Through the use of the fiber holder, you can achieve holding and clamping of a 12-core ribbon fiber having a diameter of 200 μm, but can also make the new fiber use the original fusion splicer, to ensure the quality of welding while reducing costs.

2. The present invention can be simultaneously placed on fiber cleavers and fusion splicers. For the 12-core ribbon fiber having a diameter of 200 μm, after the cutting is completed on the fiber cleaver, the holder is directly removed and installed on the fusion splicer so that the cutting angle can be maintained at the time of welding, reducing the welding loss and improving the welding efficiency.

### DESCRIPTION OF DRAWINGS

FIG. 1 is a schematic view showing the overall structure of the fiber holding tool according to the present invention;

FIG. 2 is a schematic view showing the overall structure of the fiber holding tool holding fiber according to the present invention;

FIG. 3 is an enlarged view of the body portion of the fiber holding tool according to the present invention;

FIG. 4 is a schematic view of the fiber holding tool placed on the fiber cleave according to the present invention;

FIG. 5 is a schematic view of the fiber holding tool placed on the fusion splicer according to the present invention.

Reference numbers in the figure:

| | |
|---|---|
| 1 | Body |
| 11 | Fiber accommodating groove |
| 12 | Rib |
| 13 | Fiber limiting front portion |
| 14 | Fiber limiting rear portion |
| 15 | Magnet |
| 16 | Elastic body accommodating groove |
| 17 | Connection fixing hole2 Cover |
| 21 | Fiber fixing portion |
| 22 | Elastic body |
| 3 | Rotating shaft |

### DETAILED DESCRIPTION OF EMBODIMENTS

Hereinafter, the present invention will be described further with reference to the preferred embodiments and the accompanying drawings.

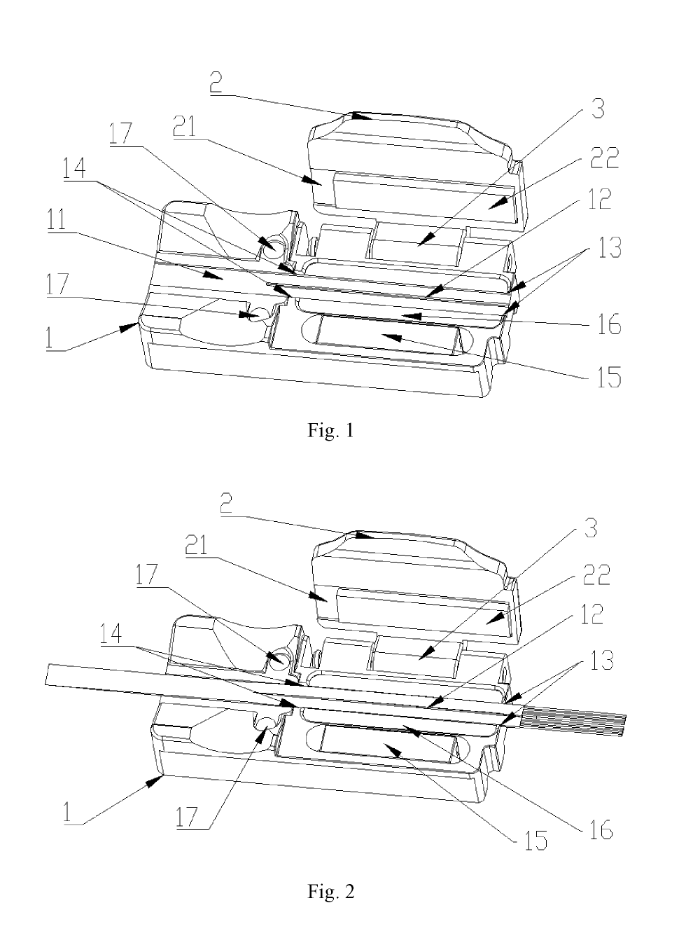

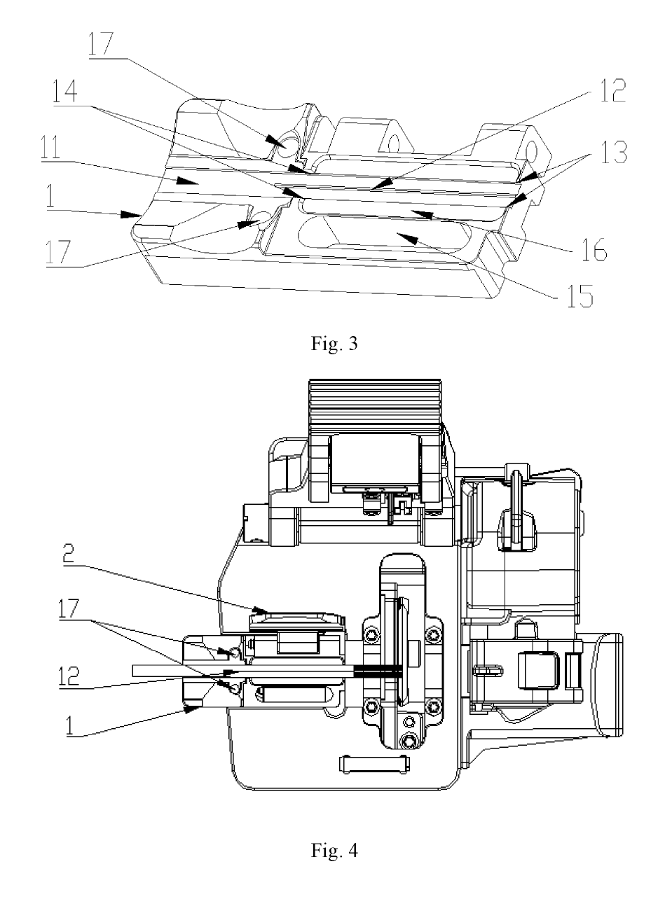

As shown in FIG. 1, the present invention discloses a fiber holding tool for the fusion splicer, which comprises a body 1 and a cover 2, among which, the said body 1 and the cover 2 are pivotally connected by a rotating shaft 3.

The said body 1 is provided with a fiber accommodating groove 11, used for placing a 12-core ribbon fiber having a diameter of 200 μm, and the said fiber accommodating groove 11 penetrates the said body 1 in the lengthwise direction; its width is set between 2.80 mm and 2.84 mm.

As shown in FIG. 2, the said fiber accommodating groove 11 is provided with a rib 12 which is set as a cuboid protruding the fiber accommodating groove 11. The said rib 12 is parallel to the two longer sides of the said fiber accommodating groove 11 and divides the said fiber accommodating groove 11 into two halves in the widthwise direction. The said rib 12 is longer than or equal to the said cover 2, but shorter than the said fiber accommodating groove 11.

Two sides from the said rib 12 to the fiber accommodating groove 11 are respectively used for placing a 6-core ribbon fiber having a diameter of 200 μm. Specifically, when a 12-core fiber needs cutting or welding, the 12-core fiber is longitudinally divided into two 6-core fibers from the cut end or the welding end, and the divided portions are placed on both sides of the rib 12, respectively. When the said cover 2 is closed, the cover 2 can clamp the two separate 6-core fibers.

When the fusion splicer is used for welding operation, first of all, be sure to place the cut fiber on the V groove. Welding shall be started after the fiber are placed in the V groove at both sides. Because the new 12-core ribbon fiber has a diameter of 200 μm, much smaller than the original 12-core ribbon fiber having a diameter of 250 μm, the original V groove cannot hold the new 12-core ribbon fiber having a diameter of 200 μm. The said rib 12 therefore divides the new fiber into two 6-core fibers, increasing the spacing between the fibers to match the original V groove spacing. In this way, the original fusion splicer can be used for welding.

As shown in FIG. 1, the said body 1 is provided with a fiber limiting front portion 13 and a fiber limiting rear portion 14, and the upper surface of the said fiber limiting front portion 13 and the said fiber limiting rear portion 14 is higher than the said fiber accommodating groove 11. In this embodiment, the fiber limiting front portion 13 is provided at the front end of the fiber accommodating groove 11, and the fiber limiting rear portion 14 is provided at the middle part of the fiber accommodating groove 11. When the fiber is placed in the fiber accommodating groove 11, the said fiber limiting front portion 13 and the said fiber limiting rear portion 14 can guide the fiber to be fixed in the fiber accommodating groove 11.

As shown in FIG. 1, the said cover 2 is shorter than the said body 1. The said cover 2 is provided with a fiber fixing portion 21 for fixing the fiber, and the said fiber fixing portion 21 is provided with an elastic body 22 for clamping the fibers in the said fiber accommodating groove 11. The said elastic body 22 protrudes the inner surface of the said cover 2 and its width is larger than that of the said fiber accommodating groove 11.

Moreover, the said body 1 is also provided with an elastic body accommodating groove 16 which is located at both sides of the said fiber accommodating groove 11. The said elastic body accommodating groove 16 is longer than or equal to the said elastic body 22 in length, and fit with the said elastic body 22 in height and width, with its bottom higher than the said fiber accommodating groove 11 but lower than the said fiber limiting front portion 13 and fiber limiting rear portion 14. When the said cover 2 is engaged with the body 1, the said elastic body 22 can clamp the fiber at a position corresponding to the fiber accommodating groove 11 so that the fiber placed in the said fiber accommodating groove 11 cannot be moved in the vertical direction, and the remainder of the elastic body 22 falls into the elastic body accommodating groove 16.

Further, the said body 1 is provided with a magnet 15, and the said cover 2 is made of a magnetic material. One end of the said cover 2 may be connected to the said body 1 through the magnet 15 to close the said cover.

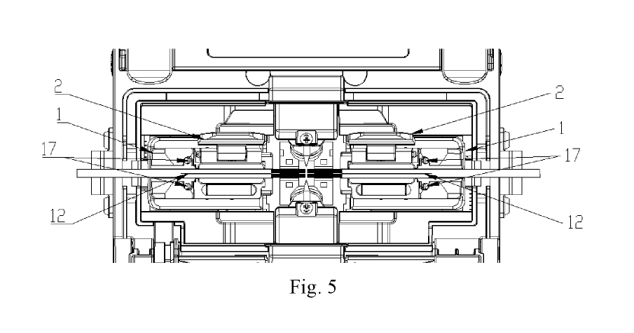

As shown in FIG. 4 and FIG. 5, the said body 1 is also provided with a plurality of connection fixing holes 17 for permanent connection with fiber cleavers and fusion splicers. In this embodiment, the number of the connection fixing holes 17 is two, and the connection with the fiber cleaver and the fusion splicer can be screwed.

1. A fiber holding tool for the fusion splicer, which comprises a body and a cover, among which, the said body and the cover are pivotally connected by a rotating shaft, wherein:
the said body is provided with a fiber accommodating groove, and the said fiber accommodating groove penetrates the said body in the lengthwise direction; the said fiber accommodating groove is provided with a rib, and the said rib is parallel to the two longer sides of the said fiber accommodating groove and divides the said fiber accommodating groove into two halves in the widthwise direction;
the said cover is provided with a fiber fixing portion for fixing the fiber, and the said cover is shorter than the said body.

2. The fiber holding tool for the fusion splicer according to claim 1, wherein:
the said rib is longer than or equal to the said cover but shorter than the said fiber accommodating groove.

3. The said fiber holding tool for the fusion splicer according to claim 2, wherein:
the said body is provided with a fiber limiting front portion and a fiber limiting rear portion, and the upper surface of the said fiber limiting front portion and the said fiber limiting rear portion is higher than the said fiber accommodating groove.

4. The said fiber holding tool for the fusion splicer according to claim 3, wherein:
the said fiber accommodating groove is used for placing a 12-core ribbon fiber having a diameter of 200 μm, and both sides from the said rib to the said fiber accommodating groove are respectively used for placing a 6-core fiber having an inner diameter of 200 μm. The width of the said fiber accommodating groove is set between 2.80 mm and 2.84 mm.

5. The said fiber holding tool for the fusion splicer according to claim 4, wherein:
the said fiber fixing portion on the said cover is provided with an elastic body, and the said elastic body protrudes from the inner surface of the said cover.

6. The said fiber holding tool for the fusion splicer according to claim 5, wherein:
the said body is also provided with an elastic body accommodating groove which is located at the both sides of the said fiber accommodating groove, the said elastic body accommodating groove is longer than or equal to the said elastic body in length, and fit with the said elastic body in height and width, with its bottom higher than the said fiber accommodating groove but lower than the said fiber limiting front portion and fiber limiting rear portion.

7. The said fiber holding tool for the fusion splicer according to claim 6, wherein:
the said body is provided with a magnet, and the said cover is made of a magnetic material. One end of the said cover may be connected to the said body through the magnet to close the said cover.

8. The said fiber holding tool for the fusion splicer according to claim 7, wherein:
the said body is also provided with a plurality of connection fixing holes for permanent connection with fiber cleavers and fusion splicers.
